(19) United States
(12) Patent Application Publication
(10) Pub. No.: US 2026/0172915 A1
(43) Pub. Date: Jun. 18, 2026

(54) UNIFIED FRAMEWORK FOR INTER-NETWORK-NODE LOWER LAYER TRIGGERED MOBILITY

(71) Applicant: QUALCOMM Incorporated, San Diego, CA (US)

(72) Inventors: Naeem AKL, Bridgewater, NJ (US); Jelena DAMNJANOVIC, Del Mar, CA (US); Ozcan OZTURK, San Diego, CA (US)

(21) Appl. No.: 18/978,421

(22) Filed: Dec. 12, 2024

(51) Int. Cl. H04W 36/00; H04W 36/04

(52) U.S. Cl. CPC H04W 36/0061; H04W 36/0016; H04W 36/04

(57) ABSTRACT

Various aspects of the present disclosure generally relate to wireless communication. In some aspects, a first network node may receive an indication of a cell group configuration associated with a second network node. The first network node may receive an indication of a radio bearer configuration associated with a third network node. The first network node may transmit a candidate configuration to a user equipment (UE) attached to the first network node, wherein the candidate configuration is based at least in part on the cell group configuration and the radio bearer configuration, and wherein the candidate configuration enables inter-network-node lower layer triggered mobility (LTM) for the UE between the first network node, the second network node, and the third network node. Numerous other aspects are described.

### FIELD OF THE DISCLOSURE

Aspects of the present disclosure generally relate to wireless communication and specifically relate to techniques, apparatuses, and methods associated with a unified framework for inter-network-node lower layer triggered mobility (LTM).

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (such as time domain resources, frequency domain resources, spatial domain resources, and/or device transmit power, among other types of system resources). Such multiple-access RATs are supported by technological advancements that have been adopted in various telecommunication standards, which define common protocols that enable different wireless communication devices to communicate on a local, municipal, national, regional, or global level.

One telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (such as cellular vehicle-to-everything (CV2X) communication), multiple-subscriber implementations, high-precision positioning, and/or radio frequency (RF) sensing, among other types of device-to-device direct communication technologies. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a first network node. The method may include receiving an indication of a cell group configuration associated with a second network node. The method may include receiving an indication of a radio bearer configuration associated with a third network node. The method may include transmitting a candidate configuration to a user equipment (UE) attached to the first network node, wherein the candidate configuration is based at least in part on the cell group configuration and the radio bearer configuration, and wherein the candidate configuration enables inter-network-node lower layer triggered mobility (LTM) for the UE between the first network node, the second network node, and the third network node.

Some aspects described herein relate to a method of wireless communication performed by a UE. The method may include receiving a candidate configuration from a first network node to which the UE is attached, wherein the candidate configuration is based at least in part on a cell group configuration associated with a second network node and a radio bearer configuration associated with a third network node. The method may include performing an inter-network-node LTM based at least in part on the candidate configuration.

Some aspects described herein relate to a non-transitory computer-readable medium that stores a set of instructions for wireless communication by a first network node. The set of instructions, when executed by one or more processors of the first network node, may cause the first network node to receive an indication of a cell group configuration associated with a second network node. The set of instructions, when executed by one or more processors of the first network node, may cause the first network node to receive an indication of a radio bearer configuration associated with a third network node. The set of instructions, when executed by one or more processors of the first network node, may cause the first network node to transmit a candidate configuration to a UE attached to the first network node, wherein the candidate configuration is based at least in part on the cell group configuration and the radio bearer configuration, and wherein the candidate configuration enables inter-network-node LTM for the UE between the first network node, the second network node, and the third network node.

Some aspects described herein relate to a non-transitory computer-readable medium that stores a set of instructions for wireless communication by a UE. The set of instructions, when executed by one or more processors of the UE, may cause the UE to receive a candidate configuration from a first network node to which the UE is attached, wherein the candidate configuration is based at least in part on a cell group configuration associated with a second network node and a radio bearer configuration associated with a third network node. The set of instructions, when executed by one or more processors of the UE, may cause the UE to perform an inter-network-node LTM based at least in part on the candidate configuration.

Some aspects described herein relate to an apparatus for wireless communication at a first network node. The apparatus may include one or more memories and one or more processors coupled to the one or more memories. The one or more processors may be configured to receive an indication of a cell group configuration associated with a second network node. The one or more processors may be configured to receive an indication of a radio bearer configuration associated with a third network node. The one or more processors may be configured to transmit a candidate configuration to a UE attached to the first network node, wherein the candidate configuration is based at least in part on the cell group configuration and the radio bearer configuration, and wherein the candidate configuration enables inter-network-node LTM for the UE between the first network node, the second network node, and the third network node.

Some aspects described herein relate to an apparatus for wireless communication at a UE. The apparatus may include one or more memories and one or more processors coupled to the one or more memories. The one or more processors may be configured to receive a candidate configuration from a first network node to which the UE is attached, wherein the candidate configuration is based at least in part on a cell group configuration associated with a second network node and a radio bearer configuration associated with a third network node. The one or more processors may be configured to perform an inter-network-node LTM based at least in part on the candidate configuration.

Some aspects described herein relate to an apparatus for wireless communication. The apparatus may include means for receiving an indication of a cell group configuration associated with a first network node. The apparatus may include means for receiving an indication of a radio bearer configuration associated with a second network node. The apparatus may include means for transmitting a candidate configuration to a UE attached to the apparatus, wherein the candidate configuration is based at least in part on the cell group configuration and the radio bearer configuration, and wherein the candidate configuration enables inter-network-node LTM for the UE between the apparatus, the first network node, and the second network node.

Some aspects described herein relate to an apparatus for wireless communication. The apparatus may include means for receiving a candidate configuration from a first network node to which the apparatus is attached, wherein the candidate configuration is based at least in part on a cell group configuration associated with a second network node and a radio bearer configuration associated with a third network node. The apparatus may include means for performing an inter-network-node LTM based at least in part on the candidate configuration.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating a disaggregated network node architecture, in accordance with the present disclosure.

FIG. 3 is a diagram illustrating an example of a lower layer triggered mobility (LTM) procedure, in accordance with the present disclosure.

FIG. 4 is a diagram of an example associated with a unified framework for inter-network-node LTM, in accordance with the present disclosure.

FIGS. 5A-5C illustrate examples of a unified framework for inter-network-node LTM, in accordance with the present disclosure.

FIG. 6 illustrates examples of candidate configurations for inter-network-node LTM, in accordance with the present disclosure.

FIG. 7 is a diagram illustrating an example process performed, for example, at a first network node or an apparatus of a first network node, in accordance with the present disclosure.

FIG. 8 is a diagram illustrating an example process performed, for example, at a UE or an apparatus of a UE, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. In some cases, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

To enhance multi-beam operation at higher carrier frequencies, a wireless network may support efficient (such as low latency and/or low overhead) downlink and/or uplink beam management operations to support Layer 1 and/or Layer 2 (L1/L2)-centric inter-cell mobility. In some cases, L1/L2 signaling may be referred to as “lower-layer” signaling and may be used to activate and/or deactivate candidate cells in a set of cells configured for lower-layer triggered mobility (LTM). Accordingly, one goal for L1/L2-centric inter-cell mobility is to enable a user equipment (UE) to perform a cell switch via dynamic control signaling at lower layers (such as downlink control information (DCI) for L1 signaling or a medium access control (MAC) control element (MAC-CE) for L2 signaling), rather than semi-static Layer 3 (L3) radio resource control (RRC) signaling, in order to reduce latency, reduce overhead, and/or otherwise increase efficiency of the cell switch.

In some cases, a UE may perform may be intra-network-node LTM to switch between cells provided by a same network node (such as a switch between different distributed units (DUs) associated with a same central unit (CU)). In these cases, a UE may perform a set of layer 3 (L3) measurements and may transmit a measurements report indicating the L3 measurements to a network node. The network node may identify a group of candidate cells for LTM based at least in part on the measurements report. In some cases, the network node may provide, to the UE, information identifying the group of candidate cells (such as a list of candidate cells included in the group of candidate cells) and/or a configuration for each candidate cell.

In some cases, the UE may store the information identifying the group of candidate cells and/or the configuration for each candidate cell for use during a subsequent LTM switch to one of the candidate cells. In some cases, the UE may perform a set of L1 measurements and/or perform synchronization with one or more of the candidate cells included in the group of candidate cells. The UE may generate an LT measurement based at least in part on performing the set of L1 measurements and/or the synchronization and may transmit the L1 measurement report to the network node.

In some cases, the L1 measurement report may indicate that the source cell (such as a cell associated with the network node) is degrading and/or that communications between the UE and the network can be improved by having the UE switch to one of the candidate cells for which the UE has previously received and stored the configuration. In these cases, the network node may transmit a MAC-CE that includes a handover command (also referred to herein as an LTM cell switch command).

In some cases, the UE may receive the handover command and may perform a handover operation to switch to the candidate cell. Because the UE has previously received and stored the configuration for the candidate cell and has previously performed synchronization with the candidate cells, the UE can complete the handover to the candidate cell without having to perform a random access channel (RACH) procedure in the candidate cell. By eliminating the need to perform the RACH procedure, the UE may reduce an amount of time required to switch from a current cell to a candidate cell relative to L3 mobility (such as due to L3 mobility requiring the performance of the RACH procedure). Further, the UE can continue to move between the candidate cells for which the UE has received and stored a configuration in a similar manner (such as without having to perform a RACH procedure). The subsequent movement between the candidate cells may be referred to herein as “subsequent mobility.”

In some cases, the UE may perform inter-network-node LTM to switch between DUs associated with different CUs. In these cases, the UE may perform a set of L3 measurements, transmit a measurements report indicating the L3 measurements to a network node, and may receive information identifying the group of candidate cells and/or a configuration for each candidate cell in a manner similar to that described above with respect to performing intra-network-node LTM switching.

Further, performing an inter-network-node LTM switch may cause a UE context to be relocated from the source network node to a target network node (such as the network node to which the UE is switching). In some cases, performing an inter-network-node LTM switch may cause both radio link control (RLC) and packet data convergence protocol (PDCP) to be relocated for the control plane (such as a PDCP layer is relocated from the source CU to the target CU) and the user plane (such as an RLC layer is relocated from the source DU to the target DU).

In some cases, the relocation of the UE context may require a security update to be performed and PDCP to be re-established. In some cases, performing the security update and re-establishing the PDCP may increase an amount of signaling required and/or a complexity associated with perform the inter-network-node LTM switch.

Further, the UE may release all of the candidate configurations that are not for the cell to which the UE is switching (such as the UE performs a process to cause the configurations to no longer be stored in a memory of the UE) based at least in part on performing the security update and re-establishing the PDCP. Because the UE releases all of the other candidate configurations, inter-network-node LTM may not enable subsequent mobility by the UE.

Various aspects relate generally to enabling subsequent mobility for inter-network-node LTM. Some aspects more specifically relate to a first network node configured to generate and provide a candidate configuration for inter-network-node LTM that enables subsequent mobility for a UE. In some aspects, the candidate configuration includes a cell group configuration associated with a second network node and a radio bearer configuration associated with a third network node.

Particular aspects of the subject matter described in this disclosure can be implemented to realize one or more of the following potential advantages. In some aspects, the described techniques can be used to enable subsequent mobility for inter-network-node LTM. In some aspects, the subsequent mobility inter-network-node LTM may be configured without relocating a PDCP anchor thereby enabling inter-network-node LTM to be performed with minimal interruption to a service provided to the UE. Further, in some aspects, the described techniques can be used to enable a UE to perform multiple handovers with a single configuration.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (such as time domain resources, frequency domain resources, spatial domain resources, and/or device transmit power, among other examples). In some cases, multiple-access RATs may include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. In some cases, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC).

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (such as cellular vehicle-to-everything (CV2X) communication), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, and/or artificial intelligence or machine learning (AI/ML).

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other use cases.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

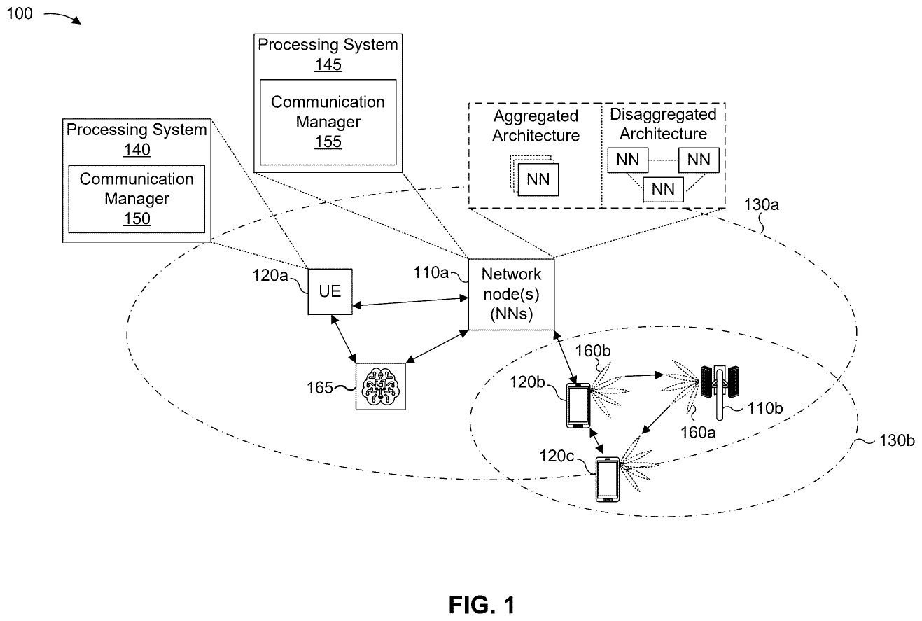

FIG. 1 is a diagram illustrating an example of a wireless communication network 100, in accordance with the present disclosure. The wireless communication network 100 may be or may include elements of a 5G (or NR) network or a 6G network, among other types of networks. The wireless communication network 100 may include multiple network nodes 110. In some cases, in FIG. 1, the wireless communication network 100 includes a network node (NN) 110a and a network node 110b. The network nodes 110 may support communications with multiple UEs 120. In some cases, in FIG. 1, the network nodes 110 support communication with a UE 120a, a UE 120b, and a UE 120c. In some cases, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. In some cases, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some cases, when multiple RATs are deployed in a given geographic area, each RAT in the geographic area may operate on different frequencies to avoid interference with other RATs. Additionally or alternatively, in some cases, the wireless communication network 100 may implement dynamic spectrum sharing (DSS), in which multiple RATs are implemented with dynamic bandwidth allocation (such as based on user demand) in a single frequency band. In some cases, the wireless communication network 100 may support communication over unlicensed spectrum, where access to an unlicensed channel is subject to a channel access mechanism. In some cases, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. In some cases, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (such as the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other cases, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some cases, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions whether referred to as software, firmware, middleware, microcode, hardware description language, or otherwise.

The processing system 140 and the processing system 145 may each include or be coupled with one or more modems (such as a cellular (such as a 5G or 6G compliant) modem). In some cases, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some cases, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other organizations or structures. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (such as a single physical structure) or may be implemented as two or more physical nodes (such as, two or more distinct physical structures). In some cases, a network node 110 may be a device or system that implements a part of a radio protocol stack, a device or system that implements a full radio protocol stack (such as a full gNB protocol stack), or a collection of devices or systems that collectively implement the full radio protocol stack. In some cases, and as shown, a network node 110 may be an aggregated network node having an aggregated architecture, meaning that the network node 110 may implement a full radio protocol stack that is physically and logically integrated within a single physical structure in the wireless communication network 100. In some cases, an aggregated network node 110 may consist of a single standalone base station or a single TRP that operates with a full radio protocol stack to enable or facilitate communication between a UE 120 and a core network of the wireless communication network 100.

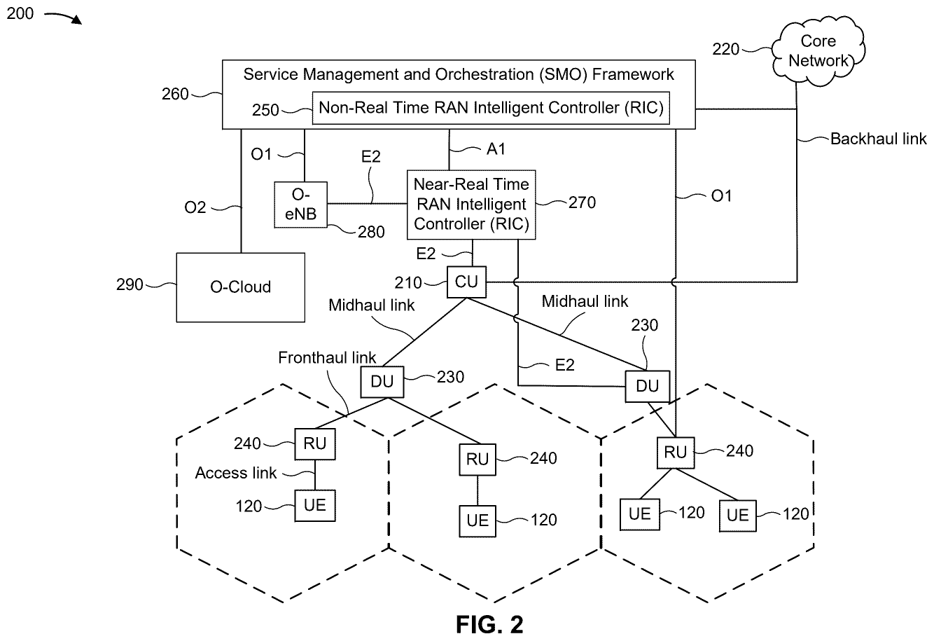

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. A disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more CUs, one or more DUs, and one or more radio units (RUs). A CU may host one or more higher layers, such as an RRC layer, a PDCP layer, and a service data adaptation protocol (SDAP) layer, among other types of higher layers. A DU may host one or more of an RLC layer, a MAC layer, and/or one or more higher physical (PHY) layers depending, at least in part, on a functional split, such as a functional split defined by the 3GPP. In some cases, a DU also may host a lower PHY layer that is configured to perform functions, such as a fast Fourier transform (FFT), an inverse FFT (IFFT), beamforming, and/or physical random access channel (PRACH) extraction and filtering, among other functions. An RU may perform RF processing functions or lower PHY layer functions, such as an FFT, an IFFT, beamforming, or PRACH extraction and filtering, among other types of RF processing functions or lower PHY layer functions, according to a functional split, such as a lower layer split (LLS). In such an architecture, each RU can be operated to handle over the air (OTA) communication with one or more UEs 120. In some cases, a single network node 110 may include a combination of one or more CUs, one or more DUs, and/or one or more RUs. In some cases, a CU, a DU, and/or an RU may be implemented as a virtual unit, such as a virtual central unit (VCU), a virtual distributed unit (VDU), or a virtual radio unit (VRU), among other types of virtual units, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (such as each cell may support communication within an angular (such as 60 degree) range around the network node). In some cases, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (such as a home) and may allow restricted access by UEs 120 having association with the femto cell (such as UEs 120 in a closed subscriber group (CSG)). In some cases, a cell may not necessarily be stationary. In some cases, the geographic area of the cell may move according to the location of an associated mobile network node 110 (such as a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (such as a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (such as a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (such as a smart watch, smart clothing, smart glasses, a smart wristband, or smart jewelry), a gaming device, an entertainment device (such as a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other types of UEs. A third category of UEs 120 may have mid-tier complexity and/or capability (such as a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other types of UEs. RedCap UEs may bridge a gap between the capability and complexity of NB-IoT devices and/or eMTC UEs, and mission-critical IoT devices and/or premium UEs. In some cases, RedCap UEs may include wearable devices, IoT devices, industrial sensors, or cameras that are associated with a limited bandwidth, power capacity, and/or transmission range, among other types of limitations or reduced capabilities. RedCap UEs may support healthcare environments, building automation, electrical distribution, process automation, transport and logistics, or smart city deployments, among other types of processes or functions.

In some cases, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (such as frames, subframes, slots, and symbols), frequency domain resources (such as frequency bands, component carriers (CCs), subcarriers, resource blocks, and resource elements), and spatial domain resources (such as particular transmit directions or beams).

Frequency domain resources may be subdivided into bandwidth parts (BWPs). A BWP may be a block of frequency domain resources (such as a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (such as by a network node 110 transmitting a DCI configuration to the one or more UEs 120) and/or reconfigured (such as in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120

is required to monitor and reduce UE power consumption by enabling the UE to monitor fewer frequency domain resources), leaving more frequency domain resources to be spread across multiple UEs 120. Thus, BWPs may also assist in the implementation of lower-capability (such as RedCap) UEs 120 by facilitating the configuration of smaller bandwidths for communication by such UEs 120 and/or by facilitating reduced UE power consumption.

As used herein, a downlink signal may be or include a reference signal, control information, or data. In some cases, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other types of downlink reference signals. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other types of information. A downlink data channel may be used to transmit downlink data (such as user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. In some cases, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. In some cases, uplink reference signals include a sounding reference signal (SRS), a PTRS, and a DMRS, among other types of uplink reference signals. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (such as user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. In some cases, a PUCCH can carry UCI, while a PUSCH can carry a MAC-CE, an RRC message, or user data, among other types of data or communications. UCI can include a scheduling request (SR), HARQ feedback information (such as a HARQ acknowledgement (ACK) indication or a HARQ negative acknowledgement (NACK) indication), uplink power control information (such as an uplink TPC parameter), and/or CSI, among other types of information. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (such as indicative of a beam used to transmit a CSI-RS), an SS/PBCH resource block indicator (SSBRI) (such as indicative of a beam used to transmit an SSB), a layer indicator (LI), a rank indicator (RI), and/or measurement information (such as, a layer 1 (L1)-reference signal received power (RSRP) parameter, a received signal strength indicator (RSSI) parameter, a reference signal received quality (RSRQ) parameter, among other types of measurement information) which can be used for beam management, among other types of information. Each PUSCH may carry one or more TBs of data.

The information (such as data, control information, or reference signal information) transmitted by a network node 110 to a UE 120, or vice versa, may be represented as a sequence of binary bits that are mapped (for example, modulated) to an analog signal waveform (such as a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some cases, the network node 110 or the UE 120 (such as using the processing system 145 or the processing system 140, respectively) may select an MCS (such as, an order of quadrature amplitude modulation (QAM), such as 64-QAM, 128-QAM, or 256-QAM, among other orders of QAM) for a downlink signal or an uplink signal. In some cases, the network node 110 may select an MCS for a downlink signal in accordance with UCI received from the UE 120. The network node 110 may transmit, to the UE 120, an indication of the selected MCS for the downlink signal, such as via DCI that schedules the downlink signal. In some cases, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other types of signal processing) to generate a processed signal in accordance with the selected MCS. In some cases, the network node 110 or the UE 120 (such as using the processing system 145 or the processing system 140, respectively, and/or one or more coupled encoders or modems) may perform a channel coding operation or a forward error correction (FEC) operation to control errors in transmitted information. In some cases, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (such as using the processing system 145 and/or one or more modems) may further perform spatial processing (such as precoding) on the encoded information to generate one or more processed or precoded signals for downlink or uplink transmission, respectively. In some cases, the network node 110 or the UE 120 may perform codebook-based precoding or non-codebook-based precoding. Codebook-based precoding may involve selecting a precoder (such as a precoding matrix) using a codebook. In some cases, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (such as using the processing system 145 or the processing system 140, respectively, and/or one or more coupled modems) may perform signal processing (such as in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other types of signal processing), to map the received signal(s) to a sequence of binary bits (such as received information) that estimates the information transmitted by the network node 110 or the UE 120 via the downlink or uplink signals. The network node 110 or the UE 120 (such as by using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some cases, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. In some cases, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. In some cases, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (such as an angle of arrival, a horizontal direction, and/or a vertical direction), a set of parameters that indicate one or more aspects of a directional signal, a direction associated with the signal, and/or a set of directional resources associated with the signal.

MIMO may be implemented using various spatial processing or spatial multiplexing operations. In some cases, MIMO may include a massive MIMO technique which may be associated with an increased (such as “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some cases, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. In some cases, an initial beam acquisition operation may involve the network node 110 transmitting signals (such as SSBs, CSI-RSs, or other signals) via respective beams (for example, of the beams 160a of the network node 110) and the UE 120 receiving and measuring the signal(s) via respective beams of multiple beams (such as from the beams 160b of the UE 120) to identify a best beam (or beam pair) for communication between the UE 120 and the network node 110. In some cases, the UE 120 may transmit an indication (such as in a message associated with a random access channel (RACH) operation) of a (best) identified beam of the network node 110 (such as by indicating an SSBRI or other identifier associated with the beam). A beam refinement operation may involve a first device (such as the UE 120 or the network node 110) transmitting signal(s) via a subset of beams (such as identified based on, or otherwise associated with, measurements reported as part of one or more other beam management operations). A second device (such as the network node 110 or the UE 120) may receive the signal(s) via a single beam (such as to identify the best beam for communication from the subset of beams). The beam(s) may be identified via one or more spatial parameters, such as a transmission configuration indicator (TCI) state and/or a quasi co-location (QCL) parameter, among other types of spatial parameters. The network node 110 and the UE 120 may increase reliability and/or achieve efficiencies in throughput, signal strength, and/or other signal properties for massive MIMO operations by performing the beam management operations.

One enhancement for multi-beam operation at higher carrier frequencies is facilitation of efficient (such as low latency and low overhead) downlink and/or uplink beam management operations to support L1 and/or L2-centric inter-cell mobility. L1/L2 signaling may be referred to as “lower layer” signaling. L1/L2 signaling may be used to activate and/or deactivate candidate cells in a set of cells configured for LTM and/or to provide reference signals for measurement by the UE 120, by which the UE 120 may select a candidate beam as a target beam for a lower layer handover operation. Accordingly, L1/L2-centric inter-cell mobility may enable a UE 120 to perform a cell switch via dynamic control signaling at lower layers (such as DCI for L1 signaling or a MAC-CE for L2 signaling), rather than semi-static L3 RRC signaling. Thus, L1/L2 centric inter-cell mobility may reduce latency, reduce overhead, and/or otherwise increase efficiency of the cell switch.

Some aspects and techniques as described herein may be implemented, at least in part, using an artificial intelligence (AI) program (referred to herein as an “AI/ML model”), such as a program that includes a machine learning (ML) model and/or an artificial neural network (ANN) model. The AI/ML model may be deployed at one or more devices 165 (such as a network node 110 and/or UEs 120). In some cases, the one or more devices 165 may include a UE 120 (such as the processing system 140), a network node 110 (such as the processing system 145), one or more servers, and/or one or more components of a cloud computing network, among other types of devices. In some cases, the AI/ML model (or an instance of the AI/ML model) may be deployed at multiple devices (such as a first portion of the AI/ML model may be deployed at a UE 120 and a second portion of the AI/ML model may be deployed at a network node 110). In other cases, a first AI/ML model may be deployed at a UE 120 and a second AI/ML model may be deployed at a network node 110. The AI/ML model(s) may be configured to enhance various aspects of the wireless communication network 100. In some cases, the AI/ML model(s) may be trained to identify patterns or relationships in data corresponding to the wireless communication network 100, a device, and/or an air interface. The AI/ML model(s) may support operational decisions relating to one or more aspects associated with wireless communications devices, networks, or services.

In some aspects, a network node 110 may include a communication manager 155. As described in more detail elsewhere herein, the communication manager 155 may receive an indication of a cell group configuration associated with a second network node; receive an indication of a radio bearer configuration associated with a third network node; and transmit a candidate configuration to a UE attached to the first network node, wherein the candidate configuration is based at least in part on the cell group configuration and the radio bearer configuration, and wherein the candidate configuration enables inter-network-node LTM for the UE between the first network node, the second network node, and the third network node. Additionally, or alternatively, the communication manager 155 may perform one or more other operations described herein.

In some aspects, a UE 120 may include a communication manager 150. As described in more detail elsewhere herein, the communication manager 150 may receive a candidate configuration from a first network node to which the UE is attached, wherein the candidate configuration is based at least in part on a cell group configuration associated with a second network node and a radio bearer configuration associated with a third network node; and perform an inter-network-node LTM based at least in part on the candidate configuration. Additionally, or alternatively, the communication manager 150 may perform one or more other operations described herein.

FIG. 2 is a diagram illustrating a disaggregated network node architecture 200, in accordance with the present disclosure. One or more components of the disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (such as via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. In some cases, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some cases, the Non-RT RIC 250 or the Near-RT RIC 270 may tune RAN behavior or performance. In some cases, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

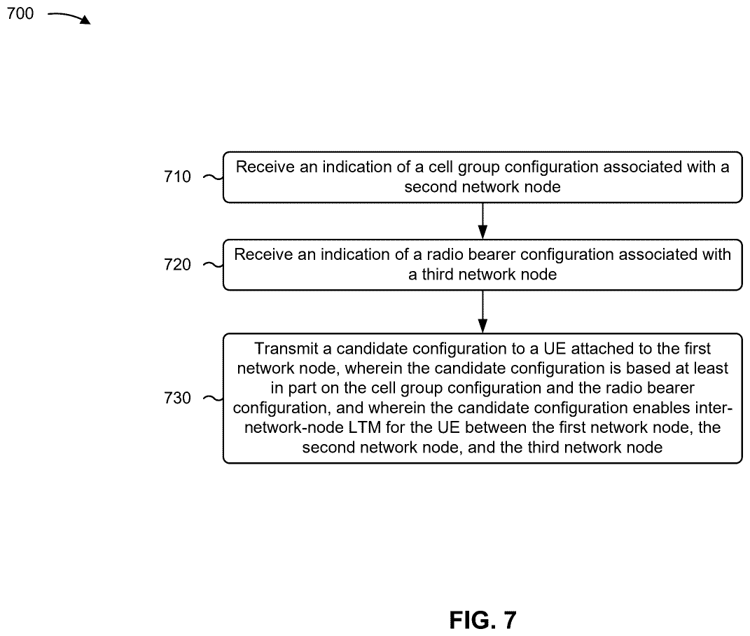

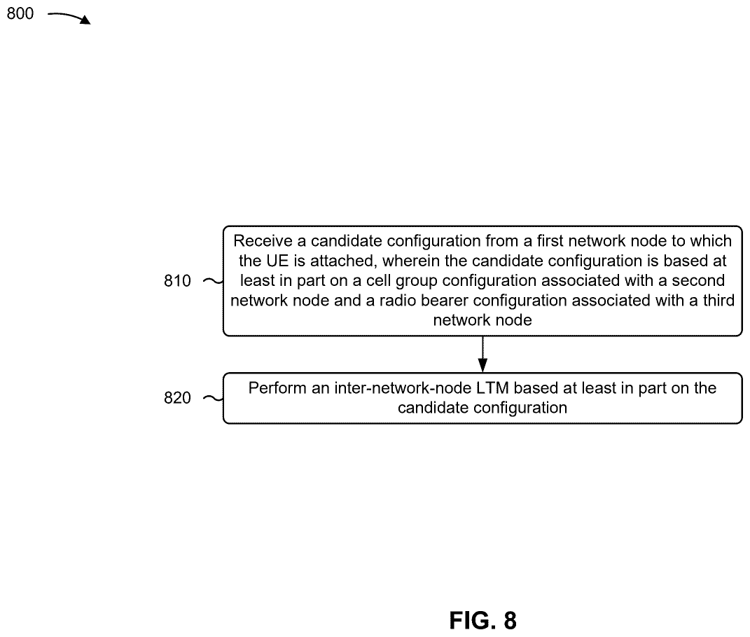

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with a unified framework for inter-network-node LTM, as described in more detail elsewhere herein. In some cases, the processing system 145 of the network node 110, the processing system 140 of the UE 120, the CU 210, the DU 230, or the RU 240 may perform or direct operations of process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some cases, the memory of the network node 110 may store data relating to a UE 120, such as RRC state information or a UE context. Memory of a UE 120 may store data and program code (or instructions) for the UE 120, such as context information. In some cases, the memory of the UE 120 or the memory of the network node 110 may include a non-transitory computer-readable medium storing a set of instructions for wireless communication. In some cases, the set of instructions, when executed by one or more processors (such as of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some cases, executing instructions may include running the instructions, converting the instructions, compiling the instructions, and/or interpreting the instructions, among other cases.

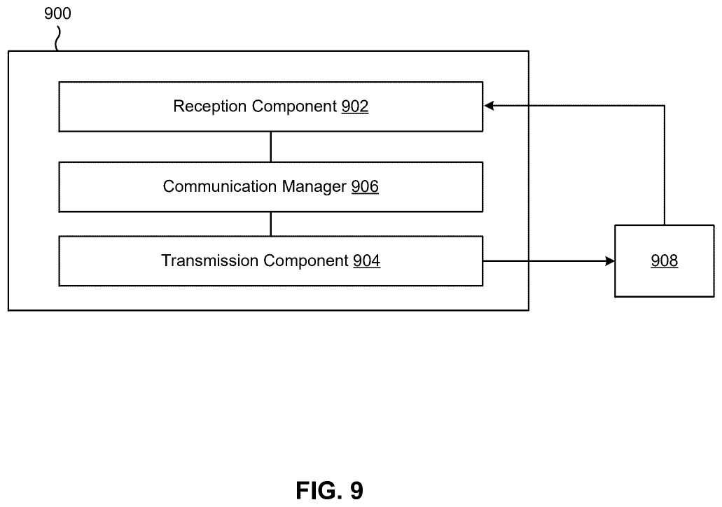

In some aspects, a network node 110 may include means for receiving an indication of a cell group configuration associated with a second network node, means for receiving an indication of a radio bearer configuration associated with a third network node; and means for transmitting a candidate configuration to a UE attached to the first network node, wherein the candidate configuration is based at least in part on the cell group configuration and the radio bearer configuration, and wherein the candidate configuration enables inter-network-node LTM for the UE between the first network node, the second network node, and the third network node. The means for the network node 110 to perform operations described herein may include, for example, one or more of communication manager 155, processing system 150, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

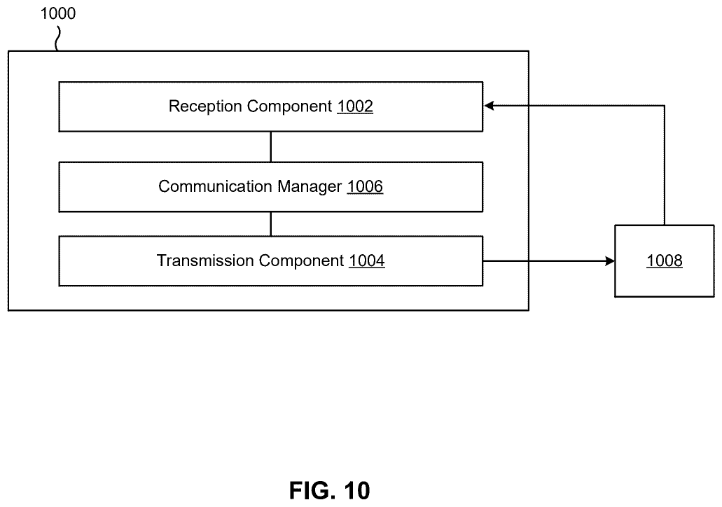

In some aspects, a UE 120 may include means for receiving a candidate configuration from a first network node to which the UE is attached, wherein the candidate configuration is based at least in part on a cell group configuration associated with a second network node and a radio bearer configuration associated with a third network node, and means for performing an inter-network node LTM based at least in part on the candidate configuration. The means for the UE 120 to perform operations described herein may include, for example, one or more of communication manager 145, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

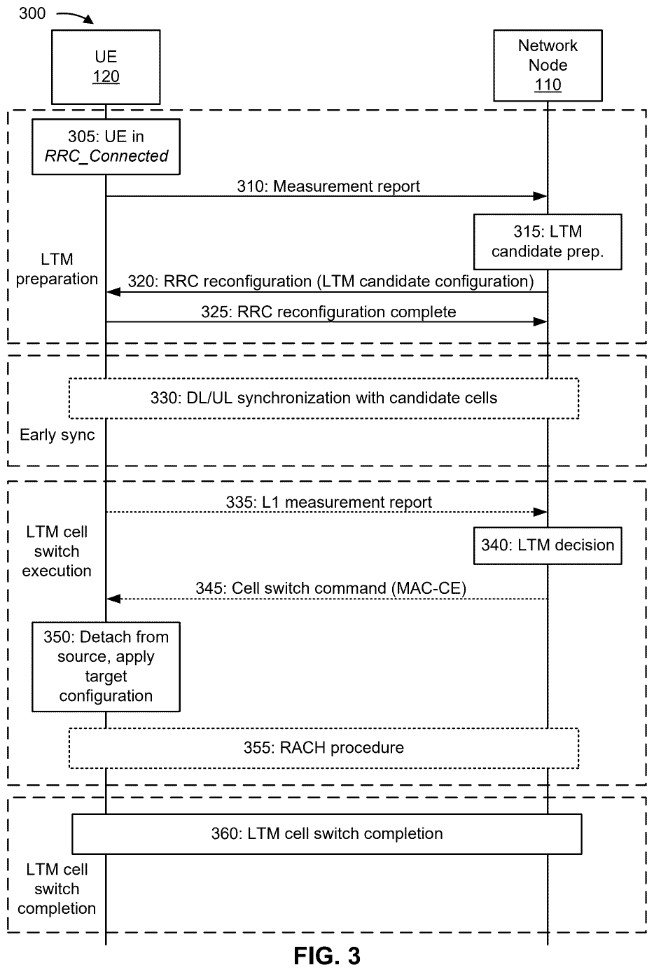

FIG. 3 is a diagram illustrating an example 300 of an LTM procedure, in accordance with the present disclosure.

In some cases, a network node 110 may instruct a UE 120 to change serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using an L3 handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighboring cells). In response to receiving the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages and/or other L3 signaling and operations used to perform the handover procedures. Accordingly, in some cases, a UE 120 may be configured to perform a lower-layer (e.g., L1 and/or L2) handover procedure, sometimes referred to an LTM procedure, such as the example 300 LTM procedure shown in FIG. 3. As shown in FIG. 3, the LTM procedure may include four phases: an LTM preparation phase, an early synchronization phase (shown as “early sync” in FIG. 3), an LTM execution phase, and/or an LTM completion phase.

During the LTM preparation phase, and as shown by reference number 305, the UE 120 may be in an RRC connected state (sometimes referred to as RRC_Connected) with a source cell. As shown by reference number 310, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, and/or CQI) or similar measurements associated with the source cell and/or one or more neighboring cells. In some cases, based at least in part on the measurement report or other information, the network node 110 may decide to use LTM, and thus, as shown by reference number 315, the network node 110 may initiate LTM candidate preparation.

As shown by reference number 320, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE and/or cells for which the UE 120 may later be triggered to perform an LTM procedure. As shown by reference number 325, the UE 120 may store the configuration of the one or more LTM candidate cell configurations and, in response, may transmit, to the network node 110, an RRC reconfiguration complete message (sometimes referred to as an RRCReconfigurationComplete message).

During the early synchronization phase, and as shown by reference number 330, the UE 120 may optionally perform downlink/uplink synchronization with the candidate cells associated with the one or more LTM candidate cell configurations. In some cases, the UE 120 may perform downlink synchronization and timing advance acquisition with the one or more candidate target cells prior to receiving an LTM switch command (which is described in more detail below in connection with reference number 335). In some cases, performing the early synchronization with the one or more candidate cells may reduce latency associated with performing a RACH procedure later in the LTM procedure, which is described in more detail below in connection with reference number 355.

During the LTM execution phase, and as shown by reference number 335, the UE 120 may perform L1 measurements on the configured LTM candidate target cells, and thus may transmit, to the network node 110, lower-layer (e.g., L1) measurement reports. As shown by reference number 340, based at least in part on the lower-layer measurement reports, the network node 110 may decide to execute an LTM cell switch to a target cell. Accordingly, as shown by reference number 345, the network node 110 may transmit, and the UE 120 may receive, a MAC-CE or similar message triggering an LTM cell switch (the MAC-CE or similar message is sometimes referred to herein as a cell switch command). The cell switch command may include an indication of a candidate configuration index associated with the target cell. As shown by reference number 350, based at least in part on receiving the cell switch command, the UE 120 may switch to the configuration of the LTM candidate target cell (e.g., the UE 120 may detach from the source cell and apply the target cell configuration). Moreover, as shown by reference number 355, the UE 120 may perform a RACH procedure towards the target cell, such as when a timing advance associated with the target cell is not available (e.g., in cases in which the UE 120 did not perform the early synchronization as described above in connection with reference number 330).

During the LTM completion phase, and as shown by reference number 360, the UE 120 may indicate successful completion of the LTM cell switch towards the target cell. In this way, cell switch to a target cell may be performed using less overhead than for an L3 handover procedure and/or a cell switch to a target cell may be associated with reduced latency as compared to L3 handover procedure.

As indicated above, FIG. 3 is provided as an example. Other examples may differ from what is described with respect to FIG. 3.

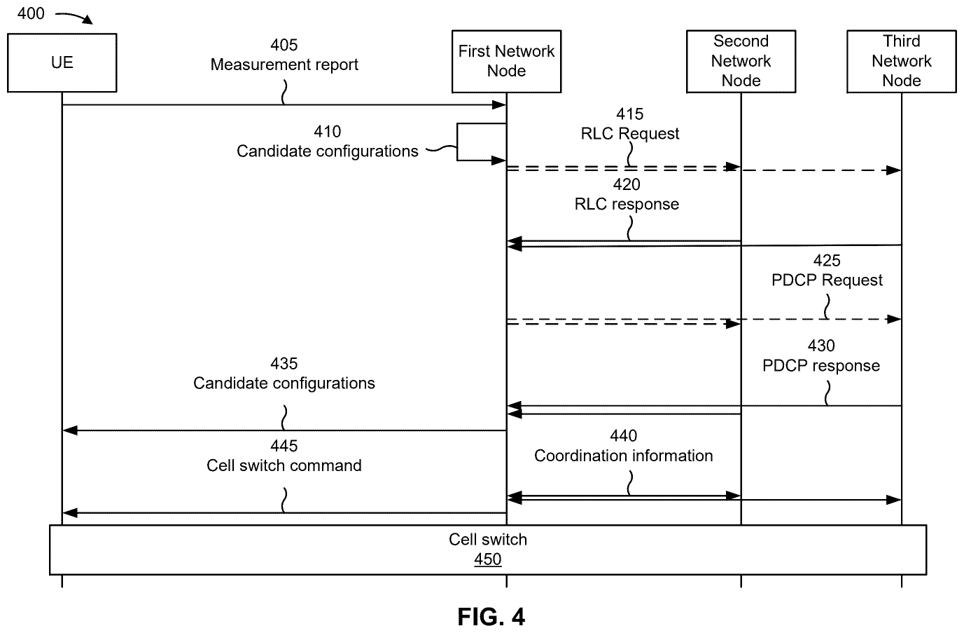

FIGS. 4, 5A-5C, and 6 are diagrams of examples 400, 500, 550, 560, 570, 580, 605, 610, 615, and 620 associated with a unified framework for inter-network-node LTM, in accordance with the present disclosure. As shown in FIG. 4, multiple network nodes (such as multiple network nodes 110) may communicate with a UE (such as a UE 120). As shown in FIG. 4, the multiple network nodes may include a first network node, a second network node, and a third network node. Although three network nodes are shown in FIG. 4, in some aspects, the multiple network nodes may include a smaller quantity of network nodes (such as two network nodes) or a greater quantity of network nodes (such as four network nodes, five network nodes, six network nodes, or the like).

In some aspects, the multiple network nodes may include one or more network nodes 110, one or more CUs, one or more DUs, one or more RUs, one or more core network nodes, one or more network servers, one or more application servers, and/or one or more Access and Mobility Management Functions (AMFs), among other types of devices or functions.

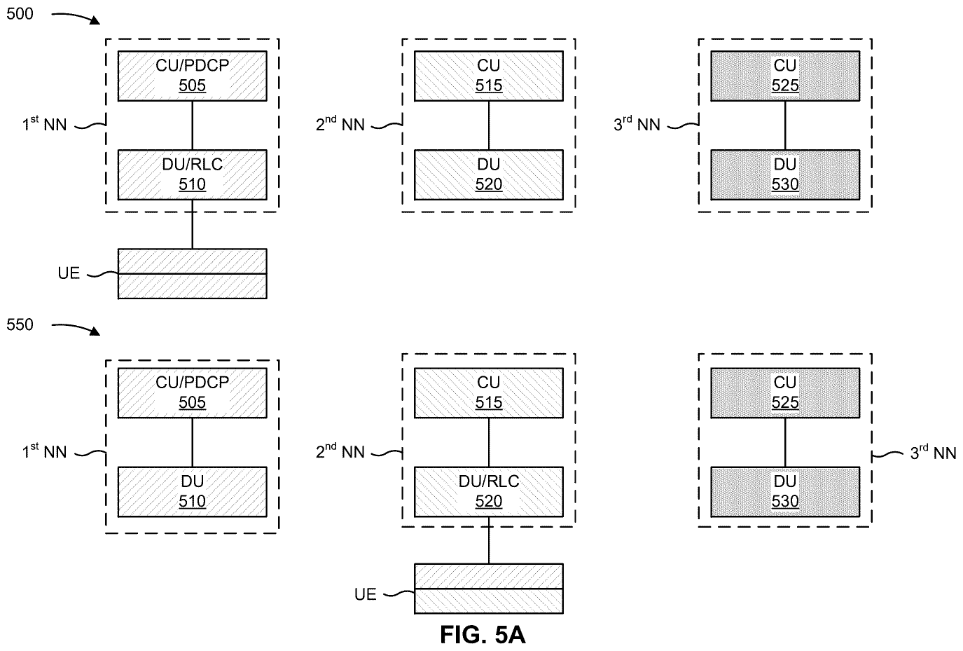

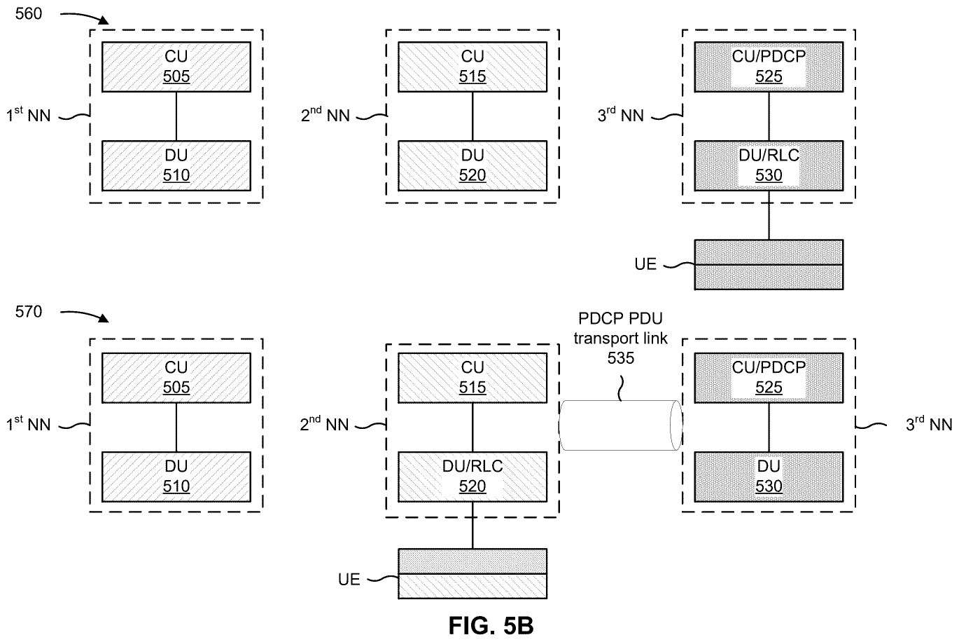

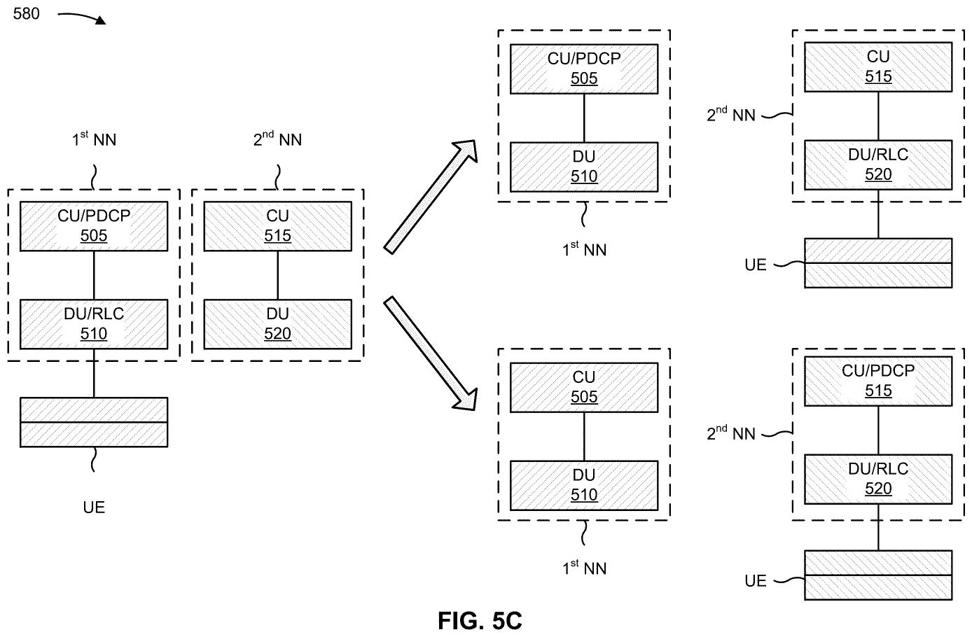

In some aspects, as shown in FIGS. 5A-5C, the first network node may include a CU 505 and a DU 510, the second network node may include a CU 515 and a DU 520, and the third network node may include a CU 525 and a DU 530.

In some aspects, the UE may be in an RRC connected state with a source cell associated with the first network node. In some aspects, as shown in FIG. 5A, and by example 500, based at least in part on the UE being in the RRC connected state with the source cell, the CU 505 may comprise a PDCP anchor with respect to the UE, and the DU 510 may comprise an RLC anchor with respect to the UE.

In some aspects, the CU 505 may be associated with a control plane of the UE based at least in part on the CU 505 comprising the PDCP anchor. In some aspects, the CU 505 may be configured to utilize PDCP to process split data streams for the UE based at least in part on the CU 505 being associated with the control plane of the UE.

In some aspects, the DU 510 may be associated with a user plane of the UE based at least in part on the DU 510 comprising the RLC anchor. In some aspects, a user plane path may be established via a communication link between the DU 510 and the UE based at least in part on the DU 510 being associated with the user plane of the UE.

With reference now to FIG. 4, as shown by reference number 405, the UE may transmit, and the first network node may receive, a measurement report. In some aspects, the UE may transmit the measurement report during an LTM preparation phase. In some aspects, the measurement report may comprise an L3 measurement report. In some aspects, the measurement report may indicate signal strength measurements (e.g., RSRP, RSSI, RSRQ, and/or CQI) or similar measurements associated with the source cell and/or one or more neighboring cells. In some aspects, based at least in part on the measurement report or other information, the network node 110 may decide to use LTM. In some aspects, the network node 110 may initiate LTM candidate preparation based at least in part on deciding to use LTM.

In some aspects, as shown by reference number 410, the first network node may determine a group of candidate configurations based at least in part on the measurement report. In some aspects, each candidate configuration, of the group of candidate configurations, may indicate one or more combinations of RLC anchors and PDCP anchors.

In some aspects, the group of candidate configurations may be determined based at least in part on a determination (such as by the first network node) as to which combinations of cell groups and PDCP anchors are to be permitted (and/or not permitted). In some aspects, each candidate configuration may indicate one or more permissible or allowed combinations of RLC anchors and PDCP anchors. In some aspects, a candidate configuration may indicate one or more impermissible or not allowed combination of RLC anchors and PDCP anchors.

In some aspects, the one or more permissible (and/or impermissible) combinations of RLC anchors and PDCP anchors indicated by a candidate configuration may be configured to support a mixture of cell switches. In some aspects, the mixture of cell switches may include an inter-network-node cell switch that requires a PDCP anchor to be relocated and/or an inter-network-node cell switch that does not require a PDCP anchor to be relocated.

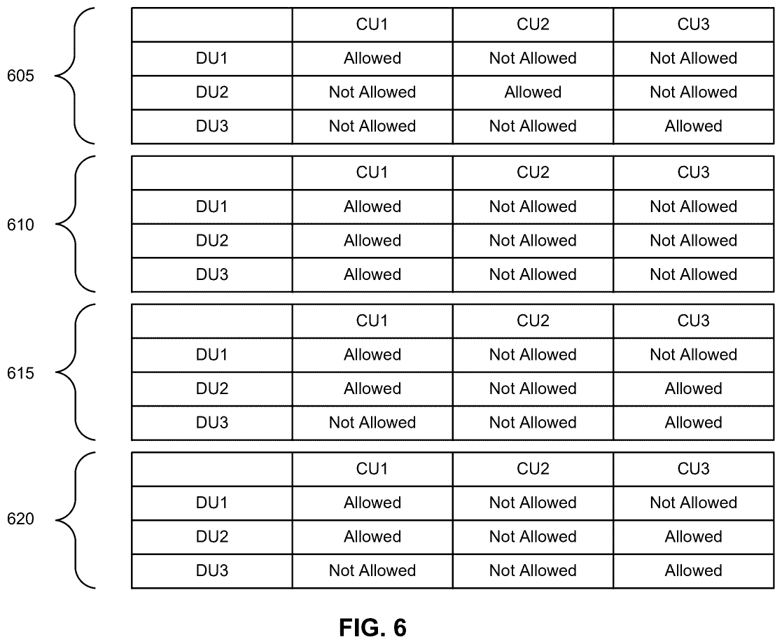

FIG. 6 illustrates examples 605, 610, 615, and 620 of candidate configurations for inter-network-node LTM, in accordance with the present disclosure. As shown in FIG. 6, in some aspects, a candidate configuration may comprise a table. A column of the table may be associated with a CU (or a DU) of a network node and a row of the table may be associated with a DU (or a CU) of a network node. An entry corresponding to an intersection of a particular row and a particular column of the table may include information indicating whether a combination of a CU associated with the particular column may comprise a PDCP anchor for the UE in combination with a DU associated with the particular row comprising an RLC anchor for the UE.

As shown in FIG. 6, example 605 illustrates a candidate configuration indicating that permissible or allowed combinations of RLC anchors and PDCP anchors include a combination of a first DU (DU1, as shown in FIG. 6) and a first CU (CU1, as shown in FIG. 6), a combination of a second DU (DU2, as shown in FIG. 6) and a second CU (CU2, as shown in FIG. 6), and a combination of a third DU (DU3, as shown in FIG. 6) and a third CU (CU3, as shown in FIG. 6). As further shown in example 605, the candidate configuration indicates that impermissible or not allowed combinations of RLC anchors and PDCP anchors include a combination of the first DU and the second CU, a combination of the first DU and the third CU, a combination of the second DU and the first CU, a combination of the second DU and the third CU, a combination of the third DU and the first CU, and a combination of the third DU and the second CU.

Examples 610, 615, and 620 illustrate candidate configurations indicating permissible and impermissible of RLC anchors and PDCP anchors in a manner similar to that of example 605.

In some aspects, the first network node may determine the permissible and/or impermissible combinations of RLC anchors and PDCP anchors based at least in part on an availability of a DU to act as an RLC anchor (such as for a particular CU/PDCP anchor) and/or an availability of a CU to act as an PDCP anchor (such as for a particular DU/RLC anchor). In some aspects, as shown in FIG. 4, and by reference number 415, the first network node may transmit an RLC request to the second network node and/or the third network node.

In some aspects, the first network node may transmit a first RLC quest to the second network node. The first RLC request may comprise a query as to whether a DU of the second network node (such as DU 520) is available to serve as an RLC anchor. In some aspects, the first RLC request may comprise a query as to whether a DU of the second network node is available to serve as an RLC anchor while the UE is served on a cell group of the first network node while the CU of the first network node (such as CU 505) serves as a PDCP anchor and/or while the CU of the third network node (such as CU 525) serves as a PDCP anchor.

In some aspects, the first RLC request may comprise a query as to whether a DU of the second network node is available to serve as an RLC anchor while the UE is served on a cell group of the second network node while the CU of the first network node serves as a PDCP anchor (such as the scenario shown in example 550 of FIG. 5A) and/or while the CU of the third network node serves as a PDCP anchor (such as the scenario shown in example 570 of FIG. 5B). In some aspects, the first RLC request may comprise a query as to whether a DU of the second network node is available to serve as an RLC anchor while the UE is served on a cell group of the third network node while the CU of the first network node serves as a PDCP anchor and/or while the CU of the third network node serves as a PDCP anchor.

In some aspects, the first network node may transmit a second RLC quest to the third network node. The second RLC request may comprise a query as to whether a DU of the third network node (such as DU 530) is available to serve as an RLC anchor. In some aspects, the second RLC request may comprise a query as to whether a DU of the third network node is available to serve as an RLC anchor while the UE is served on a cell group of the first network node while the CU of the first network node serves as a PDCP anchor and/or while the CU of the second network node (such as CU 515) serves as a PDCP anchor.

In some aspects, the second RLC request may comprise a query as to whether a DU of the third network node is available to serve as an RLC anchor while the UE is served on a cell group of the second network node while the CU of the first network node serves as a PDCP anchor and/or while the CU of the second network node serves as a PDCP anchor. In some aspects, the second RLC request may comprise a query as to whether a DU of the third network node is available to serve as an RLC anchor while the UE is served on a cell group of the third network node while the CU of the first network node serves as a PDCP anchor and/or while the CU of the second network node serves as a PDCP anchor.

As shown by reference number 420, the first network node may receive an RLC response. In some aspects, the RLC response may indicate whether a DU is available for serving as an RLC anchor. In some aspects, the RLC response may comprise a negative RLC response that includes information indicating that a DU is not available for serving as an RLC anchor.

In some aspects, the RLC response may comprise a positive RLC response that includes information indicating that the DU is available for serving as an RLC anchor. In some aspects, the positive RLC response may indicate that the DU is available to relay PDCP PDUs between the UE and another network node while the CU of the other network node serves as the PDCP anchor.

In some aspects, the positive RLC response may indicate that the DU is available for serving as an RLC anchor while the UE is served on a cell group of the network node transmitting the positive RLC response. In some aspects, the positive RLC response may indicate that the DU is available for serving as an RLC anchor while the UE is served on a cell group of another network node (such as the first network node and/or the third network node when the positive RLC response is transmitted by the second network node).

In some aspects, the information indicating that the DU is available for serving as an RLC anchor may comprise a cell group configuration. The first network node may determine that the RLC response comprises a positive RLC response based at least in part on the RLC response comprising the cell group configuration.

In some aspects, the RLC response may include a plurality of RLC responses. In some aspects, the plurality of RLC responses may include a first RLC response transmitted by the second network node. In some aspects, the first network node may receive the first RLC response based at least in part on transmitting the first RLC request to the second network node. In some aspects, the second network node may transmit the response independent of receiving an RLC request (such as the first RLC request).

In some aspects, the plurality of RLC responses may include a second RLC response transmitted by the third network node. In some aspects, the first network node may receive the second RLC response based at least in part on transmitting the second RLC request to the third network node. In some aspects, the third network node may transmit the response independent of receiving an RLC request (such as the second RLC request).

In some aspects, the first network node may transmit an indication of an RLC response to one or more network nodes. In some aspects, the first network node may receive the first RLC response from the second network node and may transmit the first RLC response and/or an indication of whether the first RLC response comprises a positive RLC response or a negative RLC response to the third network node.

In some aspects, the first network node may receive the second RLC response from the third network node. The first network node may transmit the second RLC and/or an indication of whether the second RLC comprises a positive RLC response or a negative RLC response to the second network node.

In some aspects, as shown by reference number 425, the first network node may transmit a PDCP request to the second network node and/or the third network node. In some aspects, the first network node may transmit a first PDCP quest to the second network node. The first PDCP request may comprise a query as to whether a CU of the second network node (such as CU 515) is available to serve as a PDCP anchor. In some aspects, the first PDCP request may comprise a query as to whether a CU of the second network node is available to serve as a PDCP anchor while the UE is served on a cell group of the first network node while the DU of the first network node (such as DU 510) serves as an RLC anchor and/or while the DU of the third network node (such as DU 530) serves as an RLC anchor.

In some aspects, the first PDCP request may comprise a query as to whether a CU of the second network node is available to serve as a PDCP anchor while the UE is served on a cell group of the second network node while the DU of the first network node serves as an RLC anchor and/or while the DU of the third network node serves as an RLC anchor. In some aspects, the first PDCP request may comprise a query as to whether a CU of the second network node is available to serve as a PDCP anchor while the UE is served on a cell group of the third network node while the DU of the first network node serves as an RLC anchor and/or while the DU of the third network node serves as an RLC anchor.

In some aspects, the first network node may transmit a second PDCP quest to the third network node. The second PDCP request may comprise a query as to whether a CU of the third network node is available to serve as a PDCP anchor. In some aspects, the second PDCP request may comprise a query as to whether a CU of the third network node is available to serve as a PDCP anchor while the UE is served on a cell group of the first network node while the DU of the first network node serves as an RLC anchor and/or while the DU of the second network node serves as an RLC anchor.

In some aspects, the second PDCP request may comprise a query as to whether a CU of the third network node is available to serve as a PDCP anchor while the UE is served on a cell group of the second network node while the DU of the first network node serves as an RLC anchor and/or while the DU of the second network node serves as an RLC anchor. In some aspects, the second PDCP request may comprise a query as to whether a CU of the third network node is available to serve as a PDCP anchor while the UE is served on a cell group of the third network node while the DU of the first network node serves as an RLC anchor and/or while the DU of the second network node serves as an RLC anchor.

As shown by reference number 430, the first network node may receive an PDCP response. In some aspects, the PDCP response may indicate whether a CU is available for serving as a PDCP anchor. In some aspects, the PDCP response may comprise a negative PDCP response that includes information indicating that a CU is not available for serving as a PDCP anchor.

In some aspects, the PDCP response may comprise a positive PDCP response that includes information indicating that the CU is available for serving as a PDCP anchor. In some aspects, the positive PDCP response may indicate that the CU is available to communicate PDCP PDUs with the UE and another network node while the DU of the other network node serves as the RLC anchor.

In some aspects, the positive PDCP response may indicate that the CU is available for serving as a PDCP anchor while the UE is served on a cell group of the network node transmitting the positive PDCP response. In some aspects, the positive PDCP response may indicate that the CU is available for serving as a PDCP anchor while the UE is served on a cell group of another network node (such as the first network node and/or the second network node when the positive PDCP response is transmitted by the third network node).

In some aspects, the information indicating that the DU is available for serving as a PDCP anchor may comprise a radio bearer configuration. The first network node may determine that the PDCP response comprises a positive PDCP response based at least in part on the PDCP response comprising the radio bearer configuration.

In some aspects, the PDCP response may include a plurality of PDCP responses. In some aspects, the plurality of PDCP responses may include a first PDCP response transmitted by the second network node. In some aspects, the first network node may receive the first PDCP response based at least in part on transmitting the first PDCP request to the second network node. In some aspects, the second network node may transmit the response independent of receiving a PDCP request (such as the first PDCP request).

In some aspects, the plurality of PDCP responses may include a second PDCP response transmitted by the third network node. In some aspects, the first network node may receive the second PDCP response based at least in part on transmitting the second PDCP request to the third network node. In some aspects, the third network node may transmit the response independent of receiving a PDCP request (such as the second PDCP request).

In some aspects, the first network node may transmit an indication of a PDCP response to one or more network nodes. In some aspects, the first network node may receive the first PDCP response from the second network node and may transmit the first PDCP response and/or an indication of whether the first PDCP response comprises a positive PDCP response or a negative PDCP response to the third network node.

In some aspects, the first network node may receive the second PDCP response from the third network node. The first network node may transmit the second PDCP and/or an indication of whether the second PDCP comprises a positive PDCP response or a negative PDCP response to the second network node.

In some aspects, the first network node may determine the candidate configurations (such as the permissible and/or impermissible combinations of RLC anchors and PDCP anchors) based at least in part on the RLC response and the PDCP response. In some aspects, the first network node may generate a candidate configuration indicating that a particular RLC anchor and PDCP anchor combination is permissible based at least in part on the RLC response and the PDCP response indicating that a DU and a CU are available for serving as an RLC anchor and PDCP anchor, respectively.

As shown by reference number 435, the first network node may transmit, and the UE may receive, the candidate configurations. In some aspects, the UE may store the candidate configurations for use in conjunction with future LTM operations, as described in greater detail elsewhere herein.

In some aspects, the candidate configurations may include one or more cell group configurations and/or one or more radio bearer configurations. In some aspects, the candidate configurations may include a cell group configuration associated with the DU 520, a cell group configuration associated with the DU 530, a radio bearer configuration associated with the CU 515, and/or a radio bearer configuration associated with the CU 525.

In some aspects, the candidate configurations may indicate a common cell group configuration. In some aspects, the candidate configurations may indicate that a cell group configuration associated with the DU 510 corresponds to, is the same as, or is similar to a cell group configuration associated with the DU 520 and/or the DU 530.

In some aspects, the candidate configuration may indicate a delta cell group configuration. In some aspects, the delta configuration may indicate differences between a cell group configuration associated with the DU 510 and a cell group configuration associated with the DU 520 and/or a cell group configuration associated with the DU 530.

Additionally, or alternatively, the candidate configuration information may include a cell group configuration (such as the cell group configuration associated with the DU 520 or a common cell group configuration) and a delta cell group configuration that indicates differences between the cell group configuration included in the candidate configuration information and the cell group configuration associated with the DU 530.

In some aspects, the candidate configurations may indicate a common radio bearer configuration. In some aspects, the candidate configurations may indicate that a radio bearer configuration associated with the CU 505 corresponds to, is the same as, or is similar to a radio bearer configuration associated with the CU 515 and/or the CU 525.

In some aspects, the candidate configuration may indicate a delta radio bearer configuration. In some aspects, the delta configuration may indicate differences between a radio bearer configuration associated with the CU 505 and a radio bearer configuration associated with the CU 515 and/or a radio bearer configuration associated with the CU 525.

Additionally, or alternatively, the candidate configuration information may include a radio bearer configuration (such as the radio bearer configuration associated with the CU 525 or a common radio bearer configuration) and a delta radio bearer configuration that indicates differences between the radio bearer configuration included in the candidate configuration information and the radio bearer configuration associated with the CU 525.

In some aspects, the inclusion of the common cell group configuration, the delta cell group configuration, the common radio bearer configuration, and/or the delta radio bearer configuration may reduce an amount of data or signaling transmitted to the UE with respect to transmitting a candidate configuration that includes multiple different cell group configurations and/or radio bearer configurations.

In some aspects, the first network node may coordinate LTM preparation with the second network node and/or the third network node. As shown by reference number 440, the first network node, the second network node, and the third network node may communicate to coordinate LTM preparation.

In some aspects, the communications transmitted between the first network node, the second network node, and the third network node may include control plane information. In some aspects, the first network node may receive signal radio bearer (SRB) identifiers from the second network node and may transmit the SRB identifiers received from the second network node to the third network node. In some aspects, the first network node may receive SRB identifiers from the third network node and may transmit the SRB identifiers received from the third network node to the second network node.

In some aspects, the communications transmitted between the first network node, the second network node, and the third network node may include communication channel information. In some aspects, a candidate configuration transmitted to the UE may utilize a communication channel (such as communication channel 535, shown in FIG. 5B) and the first network node may coordinate an exchange of communication information for establishing the communication channel. In some aspects, the communication channel may comprise a tunnel, a backhaul communication link, an F1-U communication link, an Xn-U communication link, and/or another type of communication channel.

In some aspects, the communication information may include an address associated with the communication channel (such as an endpoint address or an IP address), an identifier associated with the communication channel, quality of service (QoS) information, and/or another type of information associated with establish the communication channel and/or transmitting data via the communication channel.

As shown by reference number 445 the first network node may transmit a cell switch command to the UE. In some aspects, the cell switch command may include information indicating a candidate configuration included in the candidate configurations previously transmitted to the UE. In some aspects, the information indicating the candidate configuration may include an identifier associated with the candidate configuration, an identifier associated with a table of combinations of RLC anchors and PDCP anchors, or another type of information that enables the UE to identify a particular candidate configuration from the candidate configurations previously provided to the UE and/or stored in a memory of the UE.

As shown by reference number 450, the UE may perform a cell switch based at least in part on the candidate configuration. In some aspects, the UE may switch from a cell associated with the first network node to a cell associated with the second network node.

In some aspects, PDCP re-establishment may be configured at the UE based at least in part on the combination of RLC anchors and PDCP anchors indicated in the candidate configurations (rather than based at least in part on the cells associated with the cell switch). In some aspects, the cell switch may not require PDCP re-establishment.

In some aspects, as shown in FIG. 5A, prior to the cell switch, the UE may be served by a cell associated with the first network node, the DU 510 may serve as the RLC anchor, and the CU 505 may serve as the PDCP anchor. The cell switch command may a candidate configuration associated with the UE switching to a cell associated with the second network node, that the CU 505 is to serve as the PDCP anchor, and that the DU 520 is to serve as the RLC anchor. Because the CU 505 is currently serving as the PDCP anchor and will serve as the PDCP anchor after the cell switch, the cell switch may not require PDCP re-establishment.

In some aspects, the cell switch may require PDCP re-establishment. In some aspects, upon completing the cell switch described above with respect to FIG. 5A, the UE may receive a subsequent cell switch command (such as from the first network node or the second network node). The cell switch command may a candidate configuration associated with the UE switching to a cell associated with the third network node as shown in FIG. 5B and by example 560.

In some aspects, the candidate configuration may indicate that the CU 525 of the third network node is to serve as the PDCP anchor and that the DU 530 is to serve as the RLC anchor. Because the CU 505 of the first network node is currently serving as the PDCP anchor and the CU 525 of the third network node will serve as the PDCP anchor after the cell switch, the cell switch may require PDCP re-establishment.

In some aspects, the candidate configurations may include multiple candidate configurations for switching from a first cell to a second cell. In some aspects, the multiple candidate configurations may include a first candidate configuration and a second candidate configuration associated with the UE switching from the cell associated with the first network node to a cell associated with the second network node.

In some aspects, as shown in FIG. 5C, and by example 580, prior to the cell switch, the CU 505 may serve as the PDCP anchor and the DU 510 may serve as the RLC anchor. The first candidate configuration may indicate that while the UE is connected to a cell associated with the second network node, the CU 505 will serve as the PDCP anchor and the DU 520 will serve as the RLC anchor. Because the CU 505 serves as the PDCP anchor prior to, and after, the cell switch, the first candidate configuration may not require PDCP re-establishment.

In some aspects, the second candidate configuration may indicate that while the UE is connected to a cell associated with the second network node, the CU 515 will serve as the PDCP anchor and the DU 520 will serve as the RLC anchor. Because the PDCP anchor switches from the CU 505 to the CU 515, the second candidate configuration may require PDCP re-establishment.

In some aspects, the first network node may determine whether the UE is to utilize the first candidate configuration or the second candidate configuration based at least in part on one or more factors. In some aspects, the one or more factors may include a load associated with the CU 505, a load associated with the CU 515, a latency associated with the DU 520 relaying data between the UE and the CU 505, a QoS associated with data communicated between the UE and a network associated with the first network node and/or the second network node, among other factors.

As indicated above, FIGS. 4, 5A-5C, and 6 are provided as examples. Other examples may differ from what is described with respect to FIGS. 4, 5A-5C, and 6.

FIG. 7 is a diagram illustrating an example process 700 performed, for example, at a first network node or an apparatus of a first network node, in accordance with the present disclosure. Example process 700 is an example where the apparatus or the first network node (e.g., first network node 110) performs operations associated with unified framework for inter-network-node LTM.

As shown in FIG. 7, in some aspects, process 700 may include receiving an indication of a cell group configuration associated with a second network node (block 710). For example, the first network node (e.g., using reception component 902 and/or communication manager 906, depicted in FIG. 9) may receive an indication of a cell group configuration associated with a second network node, as described above.

As further shown in FIG. 7, in some aspects, process 700 may include receiving an indication of a radio bearer configuration associated with a third network node (block 720). For example, the first network node (e.g., using reception component 902 and/or communication manager 906, depicted in FIG. 9) may receive an indication of a radio bearer configuration associated with a third network node, as described above.

As further shown in FIG. 7, in some aspects, process 700 may include transmitting a candidate configuration to a user equipment (UE) attached to the first network node, wherein the candidate configuration is based at least in part on the cell group configuration and the radio bearer configuration, and wherein the candidate configuration enables inter-network-node LTM for the UE between the first network node, the second network node, and the third network node (block 730). For example, the first network node (e.g., using transmission component 904 and/or communication manager 906, depicted in FIG. 9) may transmit a candidate configuration to a UE attached to the first network node, wherein the candidate configuration is based at least in part on the cell group configuration and the radio bearer configuration, and wherein the candidate configuration enables inter-network-node LTM for the UE between the first network node, the second network node, and the third network node, as described above.

Process 700 may include additional aspects, such as any single aspect or any combination of aspects described below and/or in connection with one or more other processes described elsewhere herein.

In a first aspect, the candidate configuration is transmitted during an LTM preparation phase.

In a second aspect, process 700 includes transmitting a request for the cell group configuration to the second network node, wherein the indication of the cell group configuration is received based at least in part on the request.

In a third aspect, process 700 includes transmitting a request for the radio bearer configuration to the third network node, wherein the indication of the radio bearer configuration is received based at least in part on the request.

In a fourth aspect, process 700 includes transmitting the indication of the cell group configuration to the third network node, the indication of the radio bearer configuration to the second network node, or a combination thereof.

In a fifth aspect, the radio bearer configuration associated with the third network node, a radio bearer configuration associated with the second network node, and a radio bearer configuration associated with the first network node correspond to a same radio bearer configuration.

In a sixth aspect, the cell group configuration is based at least in part on a set of requested radio bearers.

In a seventh aspect, the radio bearer configuration is based at least in part on a set of admitted radio bearers.

In an eighth aspect, process 700 includes transmitting a request to the third network node, and receiving a response indicating whether the third network node is available to act as a PDCP anchor based at least in part on the request.

In a ninth aspect, the response comprises the radio bearer configuration.

In a tenth aspect, process 700 includes transmitting, to the second network node, information indicating that the third network node is available to act as the PDCP anchor based at least in part on the response.

In an eleventh aspect, process 700 includes transmitting a request to the second network node, and receiving a response indicating that the second network node is available to act as an RLC anchor based at least in part on the request, wherein the RLC anchor is configured to relay PDCP PDUs between the UE and the third network node.

In a twelfth aspect, the response comprises the cell group configuration.

In a thirteenth aspect, process 700 includes transmitting, to the third network node, information indicating that the second network node is available to act as the RLC anchor based at least in part on the response.

In a fourteenth aspect, a communication channel for transmitting the PDCP PDUs is established between the second network node and the third network node based at least in part on the second network node being available to act as the RLC anchor.

In a fifteenth aspect, the communication channel for transmitting the PDCP PDUs comprises an F1-U communication link or an Xn-U communication link.

In a sixteenth aspect, the first network node coordinates an exchange of communication channel information between the second network node and the third network node to establish the communication channel for transmitting the PDCP PDUs between the second network node and the third network node.

In a seventeenth aspect, the communication channel information includes an identifier associated with the communication channel, QoS information associated with the communication channel, an address associated with the second network node, an address associated with the third network node, or a combination thereof.

In an eighteenth aspect, the first network node exchanges signal radio bearer (SRB) identifiers between the second network node and the third network node.

In a nineteenth aspect, process 700 includes the indication of the cell group configuration associated with the second network node includes information indicating one or more differences between the cell group configuration associated with the second network node and a reference cell group configuration, the indication of the radio bearer configuration associated with the third network node includes information indicating one or more differences between the radio bearer configuration associated with the third network node and a reference radio bearer configuration, or a combination thereof.

In a twentieth aspect, the radio bearer configuration associated with the third network node and a radio bearer configuration associated with the first network node correspond to a common radio bearer configuration shared across a group of network nodes.

In a twenty-first aspect, the first network node comprises a CU and the second network node comprises a DU associated with the CU.

In a twenty-second aspect, the first network node comprises a first CU, and wherein the second network node comprises a DU associated with a second CU that is different from the first CU.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with unified framework for inter-network-node LTM.

As shown in FIG. 8, in some aspects, process 800 may include receiving a candidate configuration from a first network node to which the UE is attached, wherein the candidate configuration is based at least in part on a cell group configuration associated with a second network node and a radio bearer configuration associated with a third network node (block 810). For example, the UE (e.g., using reception component 1002 and/or communication manager 1006, depicted in FIG. 10) may receive a candidate configuration from a first network node to which the UE is attached, wherein the candidate configuration is based at least in part on a cell group configuration associated with a second network node and a radio bearer configuration associated with a third network node, as described above.

As further shown in FIG. 8, in some aspects, process 800 may include performing an inter-network-node LTM based at least in part on the candidate configuration (block 820). For example, the UE (e.g., using communication manager 1006, depicted in FIG. 10) may perform an inter-network-node LTM based at least in part on the candidate configuration, as described above.

Process 800 may include additional aspects, such as any single aspect or any combination of aspects described below and/or in connection with one or more other processes described elsewhere herein.

In a first aspect, the candidate configuration is received during an LTM preparation phase.

In a second aspect, the radio bearer configuration associated with the third network node, a radio bearer configuration associated with the second network node, and a radio bearer configuration associated with the first network node comprise a same radio bearer configuration.

In a third aspect, the cell group configuration is based at least in part on a set of requested radio bearers.

In a fourth aspect, the radio bearer configuration is based at least in part on a set of admitted radio bearers.

In a fifth aspect, PDCP re-establishment is configured on the UE based at least in part on a grouping of radio bearer configurations and cell group configurations included in candidate configurations received by the UE.

In a sixth aspect, process 800 includes refraining from performing PDCP re-establishment when moving between the second network node and the third network node based at least in part on the grouping of radio bearer configurations and cell group configurations included in the candidate configuration including the radio bearer configuration associated with the third network node and the cell group configuration associated with the second network node.

In a seventh aspect, process 800 includes performing PDCP re-establishment when moving between the third network node and a fourth network node based at least in part on the grouping of radio bearer configurations and cell group configurations included in the candidate configuration not including the radio bearer configuration associated with the fourth network node or a cell group configuration associated with the fourth network node.

In an eighth aspect, receiving the candidate configuration comprises receiving a plurality of candidate configurations, wherein the plurality of candidate configurations includes the candidate configuration.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a first network node, or a first network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the first network node.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the first network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the first network node described above in connection with FIG. 1, such as a radio, one or more RF chains, one or more transceivers, or one or more modems, each of which may in turn be coupled with one or more antennas of the first network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the first network node described above in connection with FIG. 1, such as a radio, one or more RF chains, one or more transceivers, or one or more modems, each of which may in turn be coupled with one or more antennas of the first network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive an indication of a cell group configuration associated with a second network node. The reception component 902 may receive an indication of a radio bearer configuration associated with a third network node. The transmission component 904 may transmit a candidate configuration to a UE attached to the first network node, wherein the candidate configuration is based at least in part on the cell group configuration and the radio bearer configuration, and wherein the candidate configuration enables inter-network-node LTM for the UE between the first network node, the second network node, and the third network node.

The transmission component 904 may transmit a request for the cell group configuration to the second network node, wherein the indication of the cell group configuration is received based at least in part on the request.

The transmission component 904 may transmit a request for the radio bearer configuration to the third network node, wherein the indication of the radio bearer configuration is received based at least in part on the request.

The transmission component 904 may transmit the indication of the cell group configuration to the third network node, the indication of the radio bearer configuration to the second network node, or a combination thereof.

The transmission component 904 may transmit a request to the third network node.

The reception component 902 may receive a response indicating whether the third network node is available to act as a PDCP anchor based at least in part on the request.

The transmission component 904 may transmit, to the second network node, information indicating that the third network node is available to act as the PDCP anchor based at least in part on the response.

The transmission component 904 may transmit a request to the second network node.

The reception component 902 may receive a response indicating that the second network node is available to act as an RLC anchor based at least in part on the request, wherein the RLC anchor is configured to relay PDCP PDUs between the UE and the third network node.

The transmission component 904 may transmit, to the third network node, information indicating that the second network node is available to act as the RLC anchor based at least in part on the response.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 3-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a candidate configuration from a first network node to which the UE is attached, wherein the candidate configuration is based at least in part on a cell group configuration associated with a second network node and a radio bearer configuration associated with a third network node. The communication manager 1006 may perform an inter-network-node lower layer mobility (LTM) based at least in part on the candidate configuration.

The communication manager 1006 may refrain from performing PDCP re-establishment when moving between the second network node and the third network node based at least in part on the grouping of radio bearer configurations and cell group configurations included in the candidate configuration including the radio bearer configuration associated with the third network node and the cell group configuration associated with the second network node.

The communication manager 1006 may perform PDCP re-establishment when moving between the third network node and a fourth network node based at least in part on the grouping of radio bearer configurations and cell group configurations included in the candidate configuration not including the radio bearer configuration associated with the fourth network node or a cell group configuration associated with the fourth network node.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a first network node, comprising: receiving an indication of a cell group configuration associated with a second network node; receiving an indication of a radio bearer configuration associated with a third network node; and transmitting a candidate configuration to a UE attached to the first network node, wherein the candidate configuration is based at least in part on the cell group configuration and the radio bearer configuration, and wherein the candidate configuration enables inter-network-node LTM for the UE between the first network node, the second network node, and the third network node.

Aspect 2: The method of Aspect 1, wherein the candidate configuration is transmitted during an LTM preparation phase.

Aspect 3: The method of any of Aspects 1-2, further comprising: transmitting a request for the cell group configuration to the second network node, wherein the indication of the cell group configuration is received based at least in part on the request.

Aspect 4: The method of any of Aspects 1-3, further comprising: transmitting a request for the radio bearer configuration to the third network node, wherein the indication of the radio bearer configuration is received based at least in part on the request.

Aspect 5: The method of any of Aspects 1-4, further comprising: transmitting the indication of the cell group configuration to the third network node, the indication of the radio bearer configuration to the second network node, or a combination thereof.

Aspect 6: The method of any of Aspects 1-5, wherein the radio bearer configuration associated with the third network node, a radio bearer configuration associated with the second network node, and a radio bearer configuration associated with the first network node correspond to a same radio bearer configuration.

Aspect 7: The method of any of Aspects 1-6, wherein the cell group configuration is based at least in part on a set of requested radio bearers.

Aspect 8: The method of any of Aspects 1-7, wherein the radio bearer configuration is based at least in part on a set of admitted radio bearers.

Aspect 9: The method of any of Aspects 1-8, further comprising: transmitting a request to the third network node; and receiving a response indicating whether the third network node is available to act as a PDCP anchor based at least in part on the request.

Aspect 10: The method of Aspect 9, wherein the response comprises the radio bearer configuration.

Aspect 11: The method of Aspect 9, further comprising: transmitting, to the second network node, information indicating that the third network node is available to act as the PDCP anchor based at least in part on the response.

Aspect 12: The method of any of Aspects 1-11, further comprising: transmitting a request to the second network node; and receiving a response indicating that the second network node is available to act as an RLC anchor based at least in part on the request, wherein the RLC anchor is configured to relay PDCP PDUs between the UE and the third network node.

Aspect 13: The method of Aspect 12, wherein the response comprises the cell group configuration.

Aspect 14: The method of Aspect 12, further comprising: transmitting, to the third network node, information indicating that the second network node is available to act as the RLC anchor based at least in part on the response.

Aspect 15: The method of Aspect 12, wherein a communication channel for transmitting the PDCP PDUs is established between the second network node and the third network node based at least in part on the second network node being available to act as the RLC anchor.

Aspect 16: The method of Aspect 15, wherein the communication channel for transmitting the PDCP PDUs comprises an F1-U communication link or an Xn-U communication link.

Aspect 17: The method of Aspect 15, wherein the first network node coordinates an exchange of communication channel information between the second network node and the third network node to establish the communication channel for transmitting the PDCP PDUs between the second network node and the third network node.

Aspect 18: The method of Aspect 17, wherein the communication channel information includes an identifier associated with the communication channel, QoS information associated with the communication channel, an address associated with the second network node, an address associated with the third network node, or a combination thereof.

Aspect 19: The method of any of Aspects 1-18, wherein the first network node exchanges SRB identifiers between the second network node and the third network node.

Aspect 20: The method of any of Aspects 1-19, wherein: the indication of the cell group configuration associated with the second network node includes information indicating one or more differences between the cell group configuration associated with the second network node and a reference cell group configuration, the indication of the radio bearer configuration associated with the third network node includes information indicating one or more differences between the radio bearer configuration associated with the third network node and a reference radio bearer configuration, or a combination thereof.

Aspect 21: The method of any of Aspects 1-20, wherein the radio bearer configuration associated with the third network node and a radio bearer configuration associated with the first network node correspond to a common radio bearer configuration shared across a group of network nodes.

Aspect 22: The method of any of Aspects 1-21, wherein the first network node comprises a CU and the second network node comprises a DU associated with the CU.

Aspect 23: The method of any of Aspects 1-22, wherein the first network node comprises a CU, and wherein the second network node comprises a DU associated with a second CU that is different from the first CU.

Aspect 24: A method of wireless communication performed by a UE, comprising: receiving a candidate configuration from a first network node to which the UE is attached, wherein the candidate configuration is based at least in part on a cell group configuration associated with a second network node and a radio bearer configuration associated with a third network node; and performing an inter-network-node LTM based at least in part on the candidate configuration.

Aspect 25: The method of Aspect 24, wherein the candidate configuration is received during an LTM preparation phase.

Aspect 26: The method of any of Aspects 24-25, wherein the radio bearer configuration associated with the third network node, a radio bearer configuration associated with the second network node, and a radio bearer configuration associated with the first network node comprise a same radio bearer configuration.

Aspect 27: The method of any of Aspects 24-26, wherein the cell group configuration is based at least in part on a set of requested radio bearers.

Aspect 28: The method of any of Aspects 24-27, wherein the radio bearer configuration is based at least in part on a set of admitted radio bearers.

Aspect 29: The method of any of Aspects 24-28, wherein PDCP re-establishment is configured on the UE based at least in part on a grouping of radio bearer configurations and cell group configurations included in candidate configurations received by the UE.

Aspect 30: The method of Aspect 29, further comprising: refraining from performing PDCP re-establishment when moving between the second network node and the third network node based at least in part on the grouping of radio bearer configurations and cell group configurations included in the candidate configuration including the radio bearer configuration associated with the third network node and the cell group configuration associated with the second network node.

Aspect 31: The method of Aspect 29, further comprising: performing PDCP re-establishment when moving between the third network node and a fourth network node based at least in part on the grouping of radio bearer configurations and cell group configurations included in the candidate configuration not including the radio bearer configuration associated with the fourth network node or a cell group configuration associated with the fourth network node.

Aspect 32: The method of any of Aspects 24-31, wherein receiving the candidate configuration comprises: receiving a plurality of candidate configurations, wherein the plurality of candidate configurations includes the candidate configuration.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (in some cases, an element “having” A may also have B). Also, as used herein, the term “or” is intended to be inclusive when used in a series and may be used interchangeably with “and/or,” unless explicitly stated otherwise (such as if used in combination with “either” or “only one of”). As used herein, a phrase referring to “at least one of” a list of items refers to any combination of those items, including single members. In some cases, “at least one of: a, b, or c” is intended to cover a, b, c, a+b, a+c, b+c, and a+b+c, as well as any combination with multiples of the same element (such as, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a first network node, comprising:
one or more memories; and
one or more processors, coupled to the one or more memories, individually or collectively configured to cause the first network node to:
receive an indication of a cell group configuration associated with a second network node;
receive an indication of a radio bearer configuration associated with a third network node; and
transmit a candidate configuration to a user equipment (UE) attached to the first network node, wherein the candidate configuration is based at least in part on the cell group configuration and the radio bearer configuration, and wherein the candidate configuration enables inter-network-node lower layer triggered mobility (LTM) for the UE between the first network node, the second network node, and the third network node.

2. The apparatus of claim 1, wherein the candidate configuration is transmitted during an LTM preparation phase.

3. The apparatus of claim 1, wherein the one or more processors are further configured to cause the first network node to:
transmit a request for the cell group configuration to the second network node, wherein the indication of the cell group configuration is received based at least in part on the request.

4. The apparatus of claim 1, wherein the one or more processors are further configured to cause the first network node to:
transmit a request for the radio bearer configuration to the third network node, wherein the indication of the radio bearer configuration is received based at least in part on the request.

5. The apparatus of claim 1, wherein the one or more processors are further configured to cause the first network node to:
transmit the indication of the cell group configuration to the third network node, the indication of the radio bearer configuration to the second network node, or a combination thereof.

6. The apparatus of claim 1, wherein the radio bearer configuration associated with the third network node, a radio bearer configuration associated with the second network node, and a radio bearer configuration associated with the first network node correspond to a same radio bearer configuration.

7. The apparatus of claim 1, wherein the cell group configuration is based at least in part on a set of requested radio bearers, the radio bearer configuration is based at least in part on a set of admitted radio bearers, or a combination thereof.

8. The apparatus of claim 1, wherein the one or more processors are further configured to cause the first network node to:
transmit a request to the third network node; and
receive a response indicating whether the third network node is available to act as a packet data convergence protocol (PDCP) anchor based at least in part on the request.

9. The apparatus of claim 8, wherein the response comprises the radio bearer configuration.

10. The apparatus of claim 8, wherein the one or more processors are further configured to cause the first network node to:
transmit, to the second network node, information indicating that the third network node is available to act as the PDCP anchor based at least in part on the response.

11. The apparatus of claim 1, wherein the one or more processors are further configured to cause the first network node to:
transmit a request to the second network node; and
receive a response indicating that the second network node is available to act as a radio link control (RLC) anchor based at least in part on the request, wherein the RLC anchor is configured to relay packet data convergence protocol (PDCP) protocol data units (PDUs) between the UE and the third network node.

12. The apparatus of claim 11, wherein the response comprises the cell group configuration.

13. The apparatus of claim 11, wherein the one or more processors are further configured to cause the first network node to:
transmit, to the third network node, information indicating that the second network node is available to act as the RLC anchor based at least in part on the response.

14. The apparatus of claim 11, wherein a communication channel for transmitting the PDCP PDUs is established between the second network node and the third network node based at least in part on the second network node being available to act as the RLC anchor.

15. The apparatus of claim 14, wherein the communication channel for transmitting the PDCP PDUs comprises an F1-U communication link or an Xn-U communication link.

16. The apparatus of claim 14, wherein the first network node coordinates an exchange of communication channel information between the second network node and the third network node to establish the communication channel for transmitting the PDCP PDUs between the second network node and the third network node.

17. The apparatus of claim 16, wherein the communication channel information includes an identifier associated with the communication channel, quality of service (QoS) information associated with the communication channel, an address associated with the second network node, an address associated with the third network node, or a combination thereof.

18. The apparatus of claim 1, wherein the first network node exchanges signal radio bearer (SRB) identifiers between the second network node and the third network node.

19. The apparatus of claim 1, wherein:
the indication of the cell group configuration associated with the second network node includes information indicating one or more differences between the cell group configuration associated with the second network node and a reference cell group configuration,
the indication of the radio bearer configuration associated with the third network node includes information indicating one or more differences between the radio bearer configuration associated with the third network node and a reference radio bearer configuration, or
a combination thereof.

20. The apparatus of claim 1, wherein the radio bearer configuration associated with the third network node and a radio bearer configuration associated with the first network node correspond to a common radio bearer configuration shared across a group of network nodes.

21. The apparatus of claim 1, wherein the first network node comprises a central unit (CU) and the second network node comprises a distributed unit (DU) associated with the CU.

22. The apparatus of claim 1, wherein the first network node comprises a first central unit (CU), and wherein the second network node comprises a distributed unit (DU) associated with a second CU that is different from the first CU.

23. A method of wireless communication performed by a first network node, comprising:
receiving an indication of a cell group configuration associated with a second network node;
receiving an indication of a radio bearer configuration associated with a third network node; and
transmitting a candidate configuration to a user equipment (UE) attached to the first network node, wherein the candidate configuration is based at least in part on the cell group configuration and the radio bearer configuration, and wherein the candidate configuration enables inter-network-node lower layer triggered mobility (LTM) for the UE between the first network node, the second network node, and the third network node.

24. The method of claim 23, wherein the candidate configuration is transmitted during an LTM preparation phase.

25. The method of claim 23, further comprising:
transmitting a request for the cell group configuration to the second network node,
wherein the indication of the cell group configuration is received based at least in part on the request.

26. The method of claim 23, further comprising:
transmitting a request for the radio bearer configuration to the third network node,
wherein the indication of the radio bearer configuration is received based at least in part on the request.

27. The method of claim 23, further comprising:
transmitting the indication of the cell group configuration to the third network node, the indication of the radio bearer configuration to the second network node, or a combination thereof.

28. The method of claim 23, wherein the radio bearer configuration associated with the third network node, a radio bearer configuration associated with the second network node, and a radio bearer configuration associated with the first network node correspond to a same radio bearer configuration.

29. A non-transitory computer-readable medium storing a set of instructions for wireless communication, the set of instructions comprising:
one or more instructions that, when executed by one or more processors of a first network node, cause the first network node to:
receive an indication of a cell group configuration associated with a second network node;
receive an indication of a radio bearer configuration associated with a third network node; and
transmit a candidate configuration to a user equipment (UE) attached to the first network node, wherein the candidate configuration is based at least in part on the cell group configuration and the radio bearer configuration, and wherein the candidate configuration enables inter-network-node lower layer triggered mobility (LTM) for the UE between the first network node, the second network node, and the third network node.

30. An apparatus for wireless communication, comprising:
means for receiving an indication of a cell group configuration associated with a first network node;
means for receiving an indication of a radio bearer configuration associated with a second network node; and
means for transmitting a candidate configuration to a user equipment (UE) attached to the apparatus, wherein the candidate configuration is based at least in part on the cell group configuration and the radio bearer configuration, and wherein the candidate configuration enables inter-network-node lower layer triggered mobility (LTM) for the UE between the apparatus, the first network node, and the second network node.
